(19) United States
(12) Patent Application Publication
(10) Pub. No.: US 2010/0296274 A1
(43) Pub. Date: Nov. 25, 2010

(54) SOLAR ENERGY LAMP HAVING FIBER DISPLAY

(75) Inventors: Ching-Hui Yu, Jhubei City (TW); Chih-Chen Chen, Jhubei City (TW)

Correspondence Address: STITES & HARBISON PLLC, Suite 900, 1199 N. Fairfax Street, Alexandria, VA, 22314, US

(73) Assignee: Power Light Tech. Co., Ltd., Jhubei City (TW)

(21) Appl. No.: 12/507,936

(22) Filed: Jul. 23, 2009

(30) Foreign Application Priority Data
May 25, 2009 (TW) 098117280

(51) Int. Cl. F21L 4/00

(52) U.S. Cl. 362/183

(57) ABSTRACT

The present invention discloses a solar energy lamp having a fiber display. The solar energy lamp includes a lamp support, a photovoltaic panel, a lighting module, a fiber display module and a power module. The photovoltaic panel is disposed on the lamp support and the lighting module is disposed on a housing of the lamp support for lighting. The fiber display module is located at an appropriate location of a pole set of the lamp support for watching. Besides, the power module can save the electrical power generated by the photovoltaic panel and the power module also can control the lighting module and the fiber display module to turn on or turn off. Because of the usage of the photovoltaic panel, the solar energy can be the power source of the lighting module and the fiber display module. Thus, it can achieve the purpose of saving energy.

### BACKGROUND OF THE INVENTION

1. Technical Field

The present invention relates to solar energy lamps, and more particularly, to a solar energy lamp having a fiber display and being applied as a streetlamp.

2. Description of Related Art

In view of the drain of energy resources over the world and the growth of environmental protection awareness, people now increasing use sustainable energy resources in place of the traditional energy resources. Among numerous sustainable energy resources, solar energy is the one with the most developed technologies and applications. Many governments' efforts have been directed to promote solar energy applications, especially to solar energy streetlamps.

Generally, a solar energy streetlamp utilizes a photovoltaic panel to absorb sunlight and convert solar energy into electric power to be stored in a storage device for a lighting module of the streetlamp to use. Since such a solar energy streetlamp requires no power supply wires of the grid power supply system, it is convenient to use solar energy streetlamps for illumination at night in remote districts or in mountain areas where the grid power supply system is less available. Since solar energy is absolutely a green energy source, the popularization of solar energy streetlamps is favorable to environmental protection and energy preservation.

On the other hand, display boards using LEDs for advertisement or traffic instruction are commonly provided beside the roads. These display boards consume power for lighting up the LEDs and thus displaying information. In prior art, power wires of the grid power supply system have to be arranged for supplying electric power to the display boards, which is an inconvenience to be addressed.

### SUMMARY OF THE INVENTION

One objective of the present invention is to provide a solar energy lamp having a fiber display, wherein the solar energy lamp uses a fiber display module to display information or advertisement.

Another objective of the present invention is to provide a solar energy lamp having a fiber display, wherein the solar energy lamp displays information in addition to provide illumination.

Another objective of the present invention is to provide a solar energy lamp having a fiber display, wherein the solar energy lamp takes solar energy as a power source thereof so as to power a lighting module and a fiber display module thereof, thereby achieving purposes of green energy use and environmental protection.

To achieve these and other objectives of the present invention, the solar energy lamp comprises a lamp support, at least one photovoltaic panel, a lighting module, a fiber display module, and a power module. The lamp support includes a pole set that has a first end and a second end, and a housing that is coupled with the first end, wherein the housing has a first surface and a second surface opposite to each other. The photovoltaic panel is disposed on the lamp support. The lighting module is disposed on the second surface. The fiber display module is located at the pole set. The power module has a power storage unit, which includes a control unit electrically connected with the photovoltaic panel, the lighting module, and the fiber display module, so that the control unit turns on/off the lighting module and the fiber display module, and charges/discharges the power storage unit.

By implementing the present invention, at least the following progressive functions can be achieved:

1. The solar energy lamp presents information or advertisement by using the fiber display module;

2. The solar energy lamp having the fiber display module provides information and illumination at the same time by combining the fiber displaying module to the solar energy lamp; and

3. The solar energy lamp saves energy and is environmentally friendly on the strength of the photovoltaic panel that powers the lighting module and the fiber display module by absorbing and converting solar energy.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a perspective view of a solar energy lamp having a fiber display according to a first embodiment of the present invention;

FIG. 2 is a partially enlarged view of the solar energy lamp of FIG. 1;

FIG. 3 is a perspective view of a solar energy lamp having a fiber display according to a second embodiment of the present invention;

FIG. 4 is a schematic drawing of a fiber display module of the present invention;

FIG. 5 is a block diagram of a circuit according to a first concept of the present invention;

FIG. 6A is a block diagram of a circuit according to a second concept of the present invention; and

FIG. 6B is a block diagram of a circuit according to a third concept of the present invention.

### DETAILED DESCRIPTION OF THE PREFERRED EMBODIMENTS

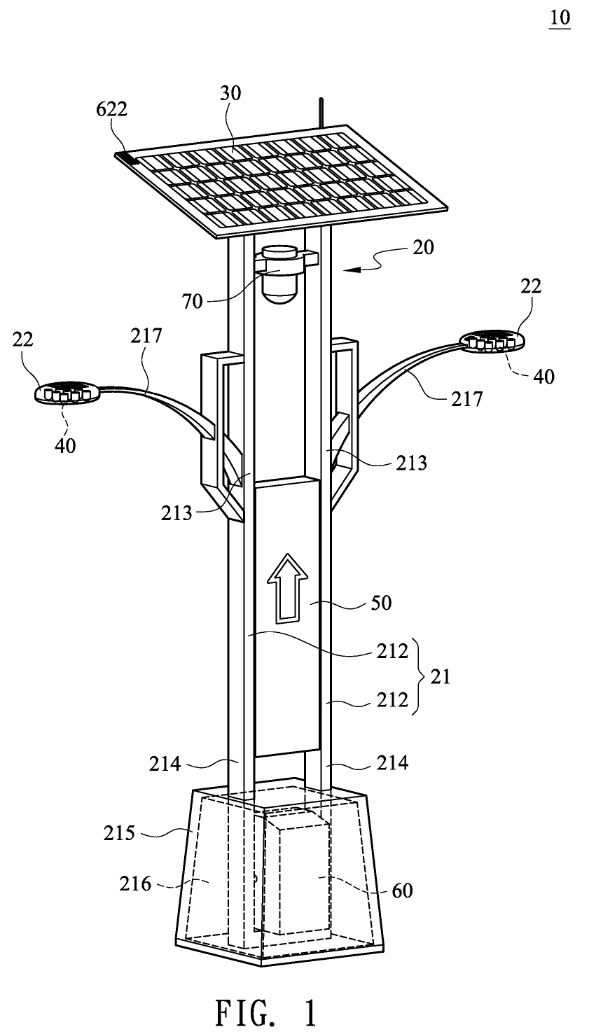

FIG. 1 illustrates a solar energy lamp 10 having a fiber display according to a first embodiment of the present invention. The solar energy lamp 10 includes a lamp support 20, at least one photovoltaic panel 30, a lighting module 40, a fiber display module 50, and a power module 60.

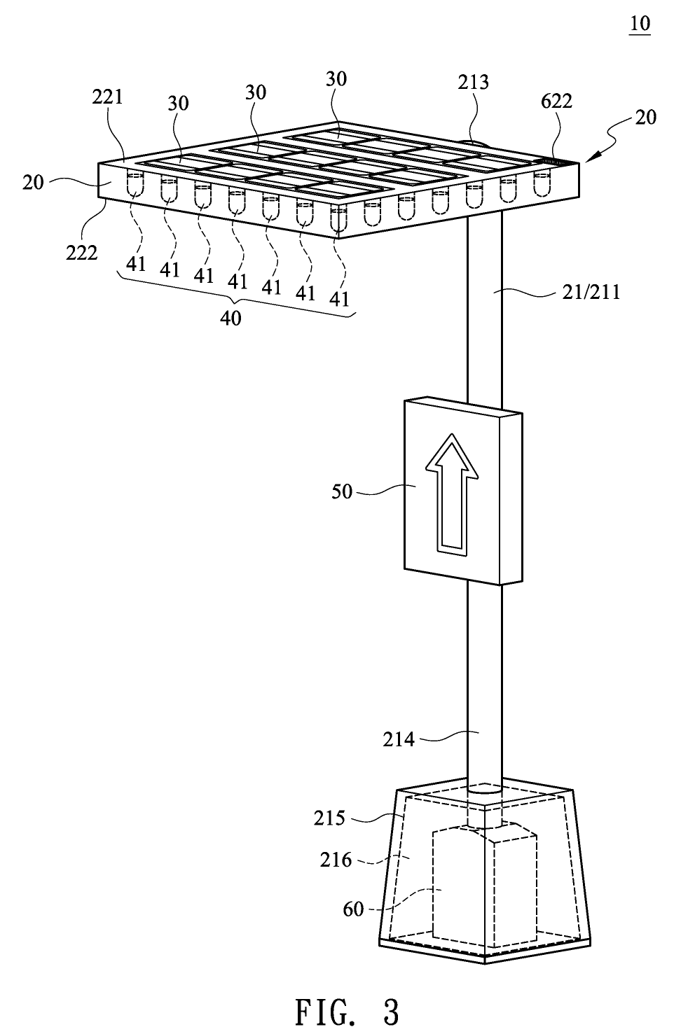

As can be seen in FIG. 1, the lamp support 20 includes a pole set 21 and a housing 22. The pole set 21 may be a single pole 211, as shown in FIG. 3, or a pair of poles 212, as shown in FIG. 1. Therein, the poles 212 may be symmetrically arranged. Furthermore, the poles 212 may be separated by a predetermined distance for allowing additional elements or devices to be settled therebetween.

Besides, the pole set 21, irrespective of being the single pole 211 or the paired poles 212, has a first end 213 and a second end 214. Therein, the first end 213 refers to the upper end of the pole set 21 while the second end 214 refers to the lower end of the pole set 21. Moreover, for firmly setting the lamp support 20 on the ground, the second end 214 of the pole set 21 may further engage with a base 215 that includes therein an accommodating space 216 for receiving the power module 60. Alternatively, the second end 214 of the pole set 21 may be not combined with the base 215 and the power module 60 may be directly attached to the second end 214 of the pole set 21 in an exposed manner for convenient maintenance (not shown).

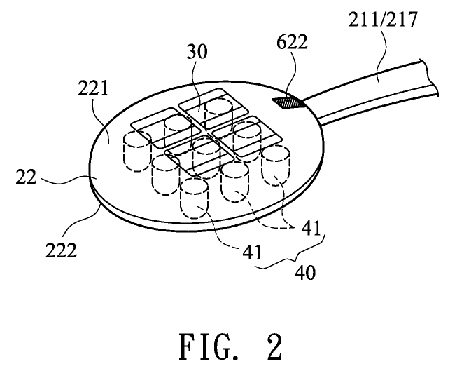

Referring to FIGS. 2 and 3, the housing 22 has a first surface 221 and a second surface 222 opposite to each other. In other words, the first surface 221 and the second surface 222 are the upper surface and the lower surface of the housing 22, respectively. According to FIG. 3, the housing 22 may be directly coupled to the first end 213 of the pole set 21. Alternatively, as shown in FIG. 1, the pole set 21 may further include a bent portion 217 extending from the first end 213 of the pole set 21 and the housing 22 may be coupled to the bent portion 217 so that the housing 22 is separated from the pole set 21 by a predetermined distance. Thereby, the housing 22 can be positioned at an appropriate location for illuminating, thus enlarging the illumination scope of the lighting module 40.

The photovoltaic panel 30 may be a silicon photovoltaic panel, a thin-film photovoltaic panel, an electrochemical photovoltaic panel, or a compound semiconductor photovoltaic panel. Different types of photovoltaic panels 30 may be implemented to meet practical needs. The solar energy lamp may have plural said photovoltaic panels 30, as shown in FIG. 3, or may use a single large-area photovoltaic panel 30, as shown in FIG. 1, as long as the area for absorbing sunlight is sufficient to ensure the capacity of the photovoltaic panel(s) 30.

The photovoltaic panel 30 is mounted atop the lamp support 20. Furthermore, referring to FIG. 1, the photovoltaic panel 30 may be mounted onto the upper end of the pole set 21. The pole set 21, in this case, may be the paired poles 212 so as to ensure the support strength thereof. Then referring to FIG. 2, said photovoltaic panel 30 may be further provided on the first surface 221 of the housing 22 so as to provide additional area of the photovoltaic panels 30 for absorbing more sunlight. In addition, as shown in FIG. 3, the photovoltaic panel 30 may be merely provided on the first surface 221 of the housing 22.

The lighting module 40 is disposed on the second surface 222 of the housing 22 for providing illumination. The lighting module 40 may include a plurality of light-emitting diodes 41. The number of the light-emitting diodes 41 may vary with different applications of the solar energy lamp 10.

The fiber display module 50 may be located at the single pole 211 of the pole set 21, as shown in FIG. 3. Alternatively, when the pole set 21 is the paired poles 212, the fiber display module 50 may be settled between the poles 212, as shown in FIG. 1. More preferably, the fiber display module 50 is flanked by the poles 212 so as to give the solar energy lamp 10 an improved overall artistic appearance.

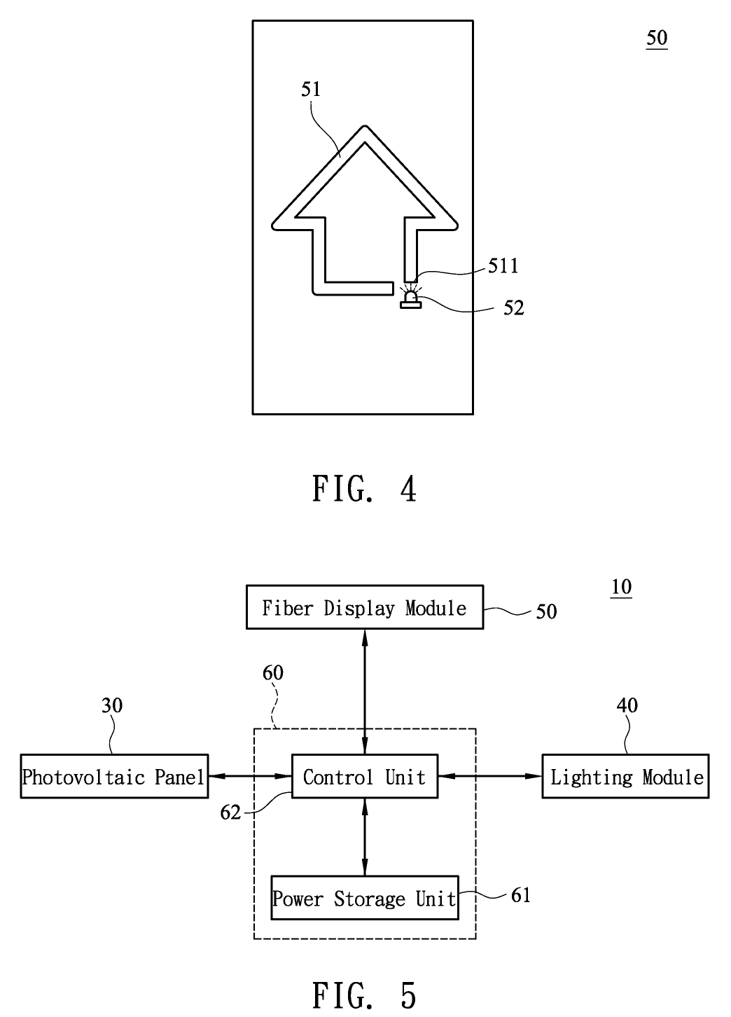

Referring to FIG. 4, the fiber display module 50 includes at least one optical fiber 51 and at least one light-emitting diode 52. The optical fiber 51 may be posed into a predetermined shape, such as a word, a symbol, or a figurative sign. Alternatively, plural said optical fibers 51 may jointly form words, symbols, or figurative signs. Each said optical fiber 51 has a light-entering end 511 for receiving light and allowing the light to enter the optical fiber 51. The light-emitting diode 52 may be provided at the light-entering end 511 of each said optical fiber 51 so that the light emitted by the light-emitting diode 52 can enter and suffuse the optical fiber 51. Plural said light-emitting diodes 52 may be of different colors so as to enable the optical fiber 51 to present different colors and give visually arresting display. Besides, each said light-emitting diode 52 is electrically connected with and powered by the power module 60 to emit light.

According to FIG. 5, the power module 60 has a power storage unit 61 and a control unit 62. The power storage unit 61 is electrically connected with the photovoltaic panel 30, the lighting module 40, and the fiber display module 50. The power storage unit 61 serves to store the electric power converted from solar energy by the photovoltaic panel 30. The control unit 62 serves to charge or discharge the power storage unit 61 according to the residual electricity in the power storage unit 61. The power storage unit 61 serves to power the light-emitting diodes 41, 52 in the lighting module 40 and the fiber display module 50. The control unit 62 also serves to turn on or turn off the lighting module 40 and the fiber display module 50 based on time setting or environmental conditions.

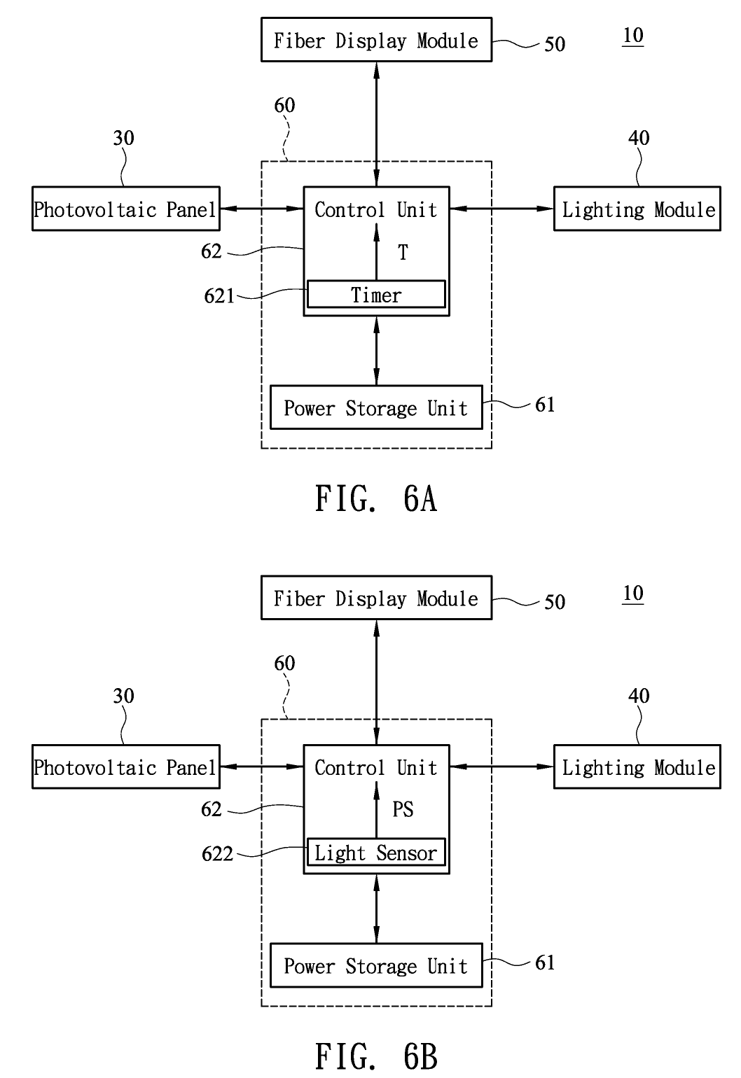

Referring to FIG. 6A, the control unit 62 may include a timer 621 that is preprogrammed with at least one time signal T so that the control unit 62 can acquire the time signal T from the timer 621 and control the lighting module 40 accordingly. For instance, the time signal T may be set differently according to different sunlit durations in different seasons so that the control unit 62 can turn on the lighting module 40 for illuminating and turn on the fiber display module 50 for displaying after sunset. Or, the control unit 62 can turn off the lighting module 40 when the sunlight is sufficient while remaining the fiber display module 50 on for displaying.

As shown in FIG. 6B, the control unit 62 has a light sensor 622. The light sensor 622 may be settled on the photovoltaic panel 30, as shown in FIG. 1, or on the lamp support 20, as shown in FIGS. 2 and 3, for detecting the intensity of ambient sunlight. The light sensor 622 generates a light-sensing signal PS so that the control unit 62 can turn on or turn off the lighting module 40 or the fiber display module 50 according to the light-sensing signal PS.

For example, when sunlight is sufficient, the light-sensing signal PS has a high value and when sunlight is insufficient, the light-sensing signal PS has a low value. Besides, when the value of the light-sensing signal PS reaches a preset threshold, it is indicated that sunlight is sufficient. Thus, the control unit 62 turns off the lighting module 40 and turns on the fiber display module 50 for displaying. When the value of the light-sensing signal PS is lower than the preset threshold, it is indicated that sunlight is insufficient. Consequently, the control unit 62 turns on the lighting module 40 for illuminating. At this time, if the power storage unit 61 has enough residual electricity, the control unit 62 also turns on the fiber display module 50 for displaying. Otherwise, the control unit 62 may turn off the fiber display module 50 for saving electric power.

Besides, as shown in FIG. 1, for monitoring the surrounding conditions, a wireless video surveillance system 70 may be provided on the solar energy lamp 10. The wireless video surveillance system 70 may be a 3G wireless video surveillance system and may be mounted on the pole set 21, or more preferably, settled between the paired poles 212 of the pole set 21.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A solar energy lamp having a fiber display, the solar energy lamp comprising:
a lamp support including:
a pole set having a first end and a second end; and
a housing coupled with the first end and having a first surface and a second surface that are opposite to each other;
at least one photovoltaic panel disposed on the lamp support;
a lighting module disposed on the second surface;
a fiber display module located at the pole set; and
a power module having a power storage unit that includes a control unit electrically connected with the photovoltaic panel, the lighting module, and the fiber display module so that the control unit turns on/off the lighting module and the fiber display, and charges/discharges the power storage unit.

2. The solar energy lamp of claim 1, wherein the pole set further includes a bent portion extending from the first end and the housing is coupled to the bent portion.

3. The solar energy lamp of claim 2, further comprising a base coupled with the second end.

4. The solar energy lamp of claim 1, further comprising a base coupled with the second end.

5. The solar energy lamp of claim 1, wherein the pole set has a pair of poles and the fiber display module is settled between the poles.

6. The solar energy lamp of claim 1, wherein the photovoltaic panel is disposed atop the pole set.

7. The solar energy lamp of claim 1, wherein the photovoltaic panel is disposed on the first surface.

8. The solar energy lamp of claim 1, wherein the lighting module includes a plurality of light-emitting diodes.

9. The solar energy lamp of claim 1, wherein the fiber display module comprises at least one optical fiber that is posed into a predetermined shape and has a light-entering end, and at least one light-emitting diode that is settled at the light-entering end, wherein the light-emitting diode is electrically connected with and powered by the power storage unit.

10. The solar energy lamp of claim 1, wherein the control unit includes a timer that is preprogrammed with at least one time signal so that the control unit turns on/off the lighting module and the fiber display module according to the time signal.

11. The solar energy lamp of claim 1, wherein the control unit has a light sensor that is settled on the lamp support and generates at least one light-sensing signal so that the control unit turns on/off the lighting module and the fiber display module according to the light-sensing signal.

12. The solar energy lamp of claim 1, further comprising a wireless video surveillance system that is disposed on the pole set.

13. The solar energy lamp of claim 5, further comprising a wireless video surveillance system that is disposed between the pair of poles.
